(19) United States
(12) Patent Application Publication
(10) Pub. No.: US 2015/0081225 A1
(43) Pub. Date: Mar. 19, 2015

(54) Method and System for the Visualization of Brain Activity

(71) Applicant: John P. Keady, Fairfax Station, VA (US)

(72) Inventors: John P. Keady, Fairfax Station, VA (US); Abigail Keady, Fairfax Station, VA (US)

(21) Appl. No.: 14/312,677

(22) Filed: Jun. 23, 2014

Related U.S. Application Data
(60) Provisional application No. 61/838,334, filed on Jun. 23, 2013.

(51) Int. Cl. G06F 19/00

(52) U.S. Cl. CPC G06F 19/3437
USPC 702/19

(57) ABSTRACT

At least one embodiment is directed to a fusion of sensors that generate a data set, where the data set identifies a visual image, where the data set is transmitted to a remote display where the visual image is displayed for a user.

### CROSS-REFERENCE TO RELATED APPLICATIONS

This application claims the benefit of U.S. provisional patent application No. 61/838334 filed on 23 Jun. 2013, incorporated herein by reference in it's entirety.

### FIELD OF THE INVENTION

The present invention relates to devices and methods that can transmit and view visual images seen by an animal, and more particularly, though not exclusively, a device that can receive data related to brain activity to reconstruct the image seen or visualized by a human.

### BACKGROUND OF THE INVENTION

Current work in brain research has attempted to map storage location in the brain of calibrated images. A useful method in both therapy and non verbal communication is needed. Several methods exist to detect the small ionic current flows akin to that which occurs in biological systems. A non-limiting example is a SQUID, fMRI, Hall Effect Sensors, and Electroencephalography. Such sensors can be combined with additional sensors, for example thermocouples.

### BRIEF DESCRIPTION OF THE DRAWINGS

Exemplary embodiments of present invention will become more fully understood from the detailed description and the accompanying drawings, wherein:

FIGS. 1A-1C illustrate training and calibration images;

FIG. 2 illustrates the viewed images being transmitted to a remote viewer;

FIG. 3 illustrates the transmission of the viewed image data to the receiver on the remote system and matching it to stored image calibration data;

FIG. 4 illustrates the transmission of the viewed image data to the receiver on the remote system and matching it to stored command/control calibration data;

FIG. 5 illustrates the transmission of the viewed image data to the receiver on the remote system and matching it to stored communication calibration data; and

FIG. 6 illustrates a non-limiting example of a sensor array.

### DETAILED DESCRIPTION OF EMBODIMENTS

The following description of exemplary embodiment(s) is merely illustrative in nature and is in no way intended to limit the invention, its application, or uses.

If one can then obtain brain activity from a subject, the data can be correlated with shapes, color, sound, feel, taste and other sensory data associated with calibrated objects, and visual scenes to determine what the subject is seeing or visualizing and communicate such data to a remote device which can then be displayed for a user to view what the subject sees.

The attached figures illustrate various methods according to embodiments. Basically a subjects brain patterns have been saved as data. The data is linked to pattern associated with a visual image, and several of the senses. For example if the brain patterns show activity in the visual region and access to several memory locations, then the activity level (e.g., oxygen level) of the several memory locations can be matched to stored patterns and a visual image simulated that should be similar to what is seen by the subject. Note that the several memory locations can be different locations associated with various senses. For example, if the highest intensities is accounted with yellow, sour smell, sour taste, and size about 3-4 inches, and the visual signals are associated with yellow and oval, then the image displayed can be oval, yellow, . . . then a separate label giving probable objects (e.g., lemons).

Types of sensors that can be used are MRI, PET, E and B field sensors, infrared sensors.

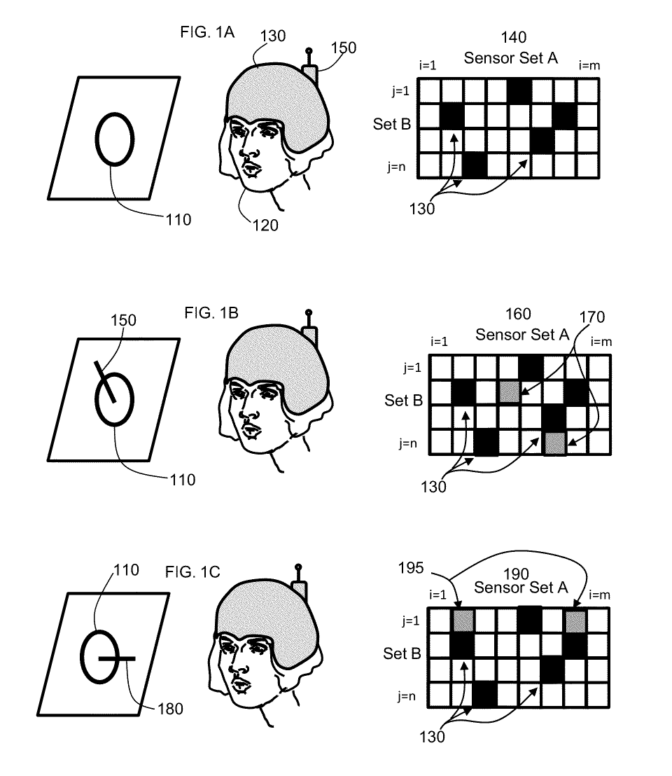

FIGS. 1A-1C illustrate training and calibration images. FIG. 1A illustrates a subject 120 viewing an image 110, where a head sensor 130 records the brain currents associated with the image. The data is transmitted, for example via RF transmitter 150, to a remote system. The data is stored as image calibrated data 130 in a data sensor set 140, associated with the particular image 110. The multiple sensor values (e.g., currents, temperatures, magnetic and electric field), which can occur in separate skull caps are stored. FIG. 1B illustrates a second image composed of image 150 combined with image 110. The data set 130 associated with image 110 is stored as well as the data set 170 associated with image 150. The entire sensor set 160 is the calibrated data associated with the combined images. Note that determination of values in the array can be in accordance to a threshold level. For example if the current is greater than 1 nanoamp a value of 1 can be assigned to the data position in the data matrix associate with the sensor taking the measurement. For example suppose the i=3, j=5 sensor measures 3 nanoamp and the threshold is 1 nanoamp. Then one possible data value from sensor i=3, j=5 would be 1, others values can be assigned also for example the actual value can be used. FIG. 1C illustrates the third image 180 with associated data 195.

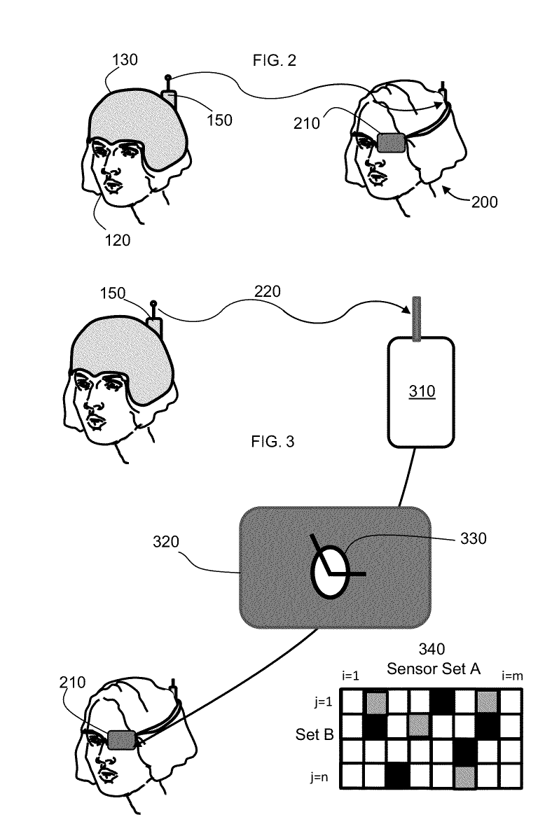

FIG. 2 illustrates the viewed images being transmitted to a remote viewer. A viewer 120 wearing a monitoring cap 130 transmits via a transmitter 150 data to a remote system (e.g., remote viewer 200). FIG. 3 illustrates that transmission 220 of the data associated with viewing is sent to a system receiver 310, which sends the data to a processor that compares the data to stored image calibration data. The processor then selects the most likely net image, for example by using least square comparison of all data sensor values 340, sending the net image 330 onto the display 320, for example onto a heads up display unit 210.

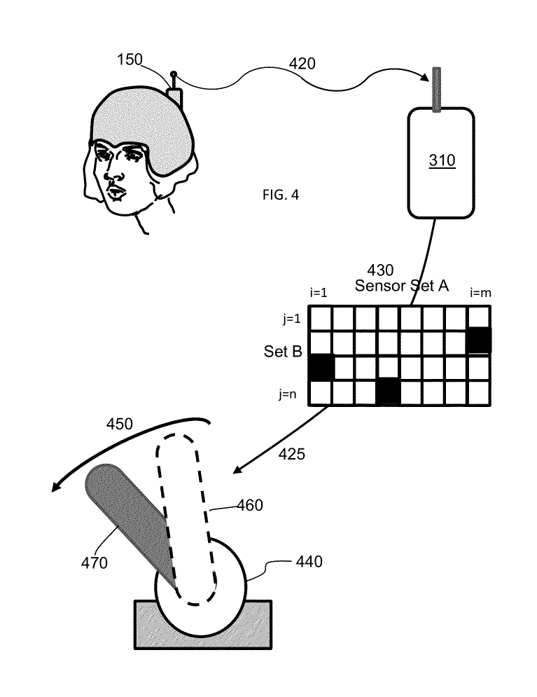

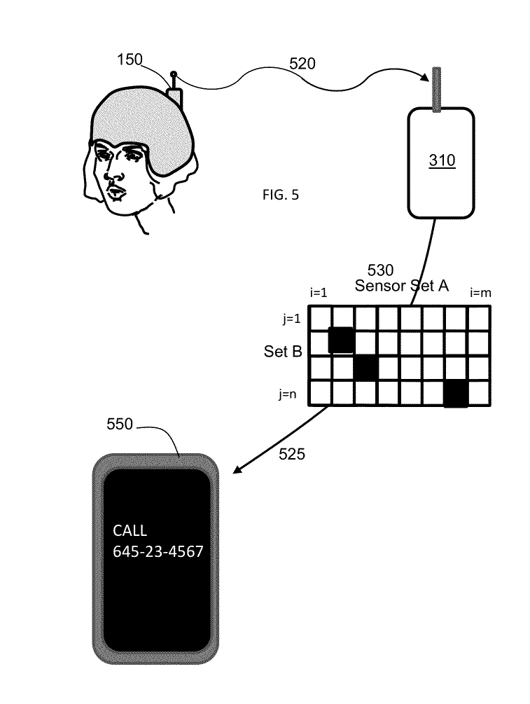

FIG. 4 illustrates that transmission 420 of the data associated with a mental command is sent to a system receiver 310, which sends the data to a processor that compares the data to stored command calibration data. The processor then selects the most likely net command to send to a system 440 (e.g., move artificial arm, rotate 450 mechanical lever from an initial position 460 to a new position 470), for example by using correlation comparison of all data sensor values 430 (e.g., choosing the command associated with an average correlation>0.9), sending the net command 425 to the system's 440 processor, where the system 440 enacts the command.

FIG. 5 illustrates that transmission 520 of the data associated with a mental command/communication request is sent to a system receiver 310, which sends the data to a processor that compares the data to stored command/communication request calibration data. The processor then selects the most likely, comparing net command/communication request to send to a communication device 550 (e.g., smart phone, TV,) for example by setting the calibrated values to 1 (values associated with 130 to 1.0) and the background to −1 (values not associated with 130 to −1), then summing the transmitted data array with calibrated data arrays until the largest net sum is achieved upon which the communication request associated with that value is chosen, comparison of all data sensor values 430 with calibrated data, sending the net command/communication request 525 to the system's 550 processor, where the system 550 enacts the command/communication request (e.g., call friend).

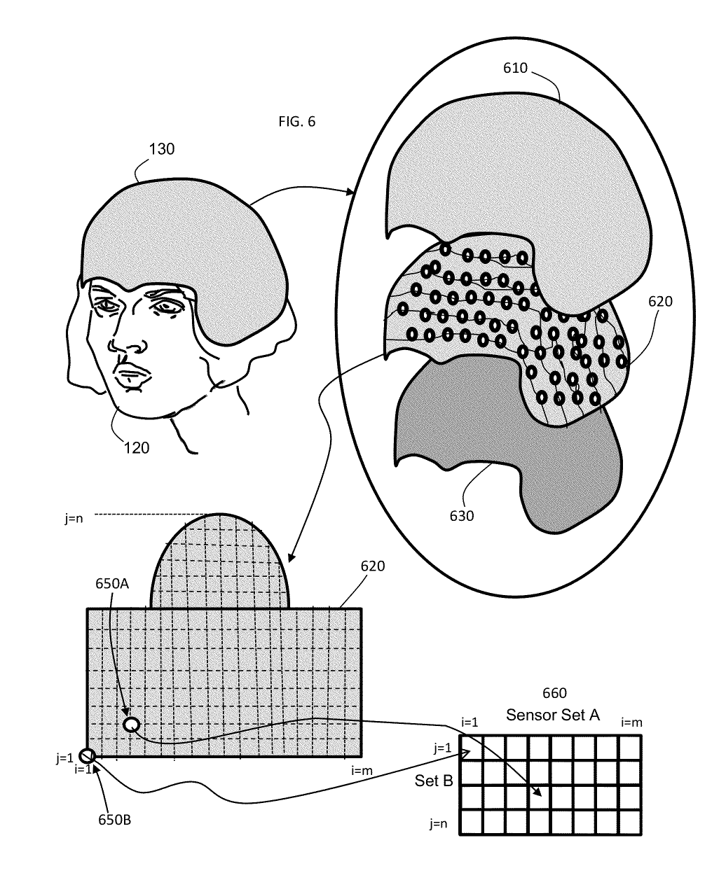

FIG. 6 illustrates a non-limiting example of a sensor array. The noon-limiting example includes a mu-metal cap 610 (flexible or non-flexible), covering at least on sensor array cap(s) 620 (hall effect sensor array cap, individually or coupled with SQUID (using room temp near superconductor) sensor array cap), with a skin contact layer 630. The sensors on the sensor array can be indexed by numerical location on a grid system (i,j). For example sensor 650A at numerical location i=4, j=3, and sensor 650 A at numerical location i=1, j=1 can be mapped to an associated i,j data array position in calibrated data set.

Note that the calibrated data set can be set up as a data matrix of multiple dimensions, with each sensor type associated with a particular sensor on a particular sensor cap. For example suppose 620 is actually composed of two overlaying data caps where the first is a hall effect sensor cap, and the second is Electroencephalography sensor cap. Thus data set matrix M(1, i,j) can be associated with calibrated values of the hall sensor cap, and M(2,i,j) can be associated with Electroencephalography sensor cap data.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions of the relevant exemplary embodiments. For example, terms such as correlation and least squares is used, and their common mathematical meaning between two matrix datasets are assumed to be incorporated by reference.

Thus, the description of the invention is merely exemplary in nature and, thus, variations that do not depart from the gist of the invention are intended to be within the scope of the exemplary embodiments of the present invention. Such variations are not to be regarded as a departure from the spirit and scope of the present invention.

What is claimed is:

1. A device for visualizing images seen by a subject comprising:
a sensor configured to read brain activity of a subject and generate a data set corresponding to the read brain activity;
a transmitter, that transfers the data set to a receiver, where the data set is stored into computer memory, where a processor compares the data set to stored calibrated data to generate a simulated image corresponding to the data set; and
a display, where the display shows the simulated image.

2. The device according to claim 1, where the display is a heads up display.

3. A device for visualizing images seen by a subject comprising:
a plurality of sensors incorporated into a cap, where the cap is configured to read brain activity of a wearer and generate a data set corresponding to the read brain activity; and
a transmitter, that transfers the data set to a receiver, where the data set is stored into computer memory, where a processor compares the data set to stored calibrated data to generate a command corresponding to the data set and send it to a device that enacts the command.
